(19) United States
(12) Patent Application Publication
(10) Pub. No.: US 2023/0110062 A1
(43) Pub. Date: Apr. 13, 2023

(54) Thumb Stretch Wedge

(71) Applicant: Michael David Daily, Los Angeles, CA (US)

(72) Inventor: Michael David Daily, Los Angeles, CA (US)

(21) Appl. No.: 17/342,982

(22) Filed: Jun. 9, 2021

(51) Int. Cl. A61H 1/02

(52) U.S. Cl. CPC A61H 1/0288; A61H 2201/165; A61H 2205/067; A61H 2201/1638

(57) ABSTRACT

The Thumb Saver is the only product of its kind that has the capability of reducing the cumulative effects of chronic typing, writing and texiing in a convenient means that can be easily employed while an individual is sitting at home or at work. The Thumb Saver is uniquely designed with a sticky, non-skid surface on the top and bottom sides to avoid the device from sliding from the hand during use and offers versatility as the product can be used for both the left and right thumb by simply flipping the product over.

### BACKGROUND

Experiencing thumb and wrist pain is a prevalent situation for individuals globally. Thumb and wrist discomfort is often credited to tendon constriction or irritation which in return causes pain and tenderness along the thumb side of the wrist. Oftentimes, repetitive stress, overuse, and constant phone usage are the main causes of pain or injury and such cumulative effects can lead to extreme discomfort and/or joint pressure which creates constant friction for individuals. There have been no products available as original equipment or as an aftermarket to address this problem.

An apparatus to help relieve thumb and wrist discomfort from joint pressure, and friction from overuse. There have been no products available as original equipment or as an aftermarket to address this problem either.

There exists a need for a device such as the Thumb Stretch Wedge that is not being met by any known or disclosed device or system of present.

### SUMMARY OF THE INVENTION

The main purpose of the Thumb Stretch Wedge is to provide users with an easy and safe way to effectively stretch their thumb and wrist to relieve excessive pressure and promote proper thumb extension.

### BRIEF DESCRIPTION OF THE DRAWINGS

FIG. 1 is a top elevational view of the Thumb Stretch Wedge on the Right hand in accordance with an embodiment of the present disclosure.

FIG. 2 is a top elevational view of the Thumb Stretch Wedge on the Left hand in accordance with an embodiment of the present disclosure.

FIG. 3 is a bottom elevational view of the Thumb Stretch Wedge in accordance with an embodiment of the present disclosure.

FIG. 4 is a side elevational view of the Thumb Stretch Wedge in accordance with an embodiment of the present disclosure.

Throughout the description, similar reference numbers may be used to identify similar elements depicted in multiple embodiments. Although specific embodiments of the invention have been described and illustrated, the invention is not to be limited to the specific forms or arrangements of parts so described and illustrated. The scope of the invention is to be defined by the claims appended hereto and their equivalents.

### DETAILED DESCRIPTION

Reference will now be made to exemplary embodiments illustrated in the drawings and specific language will be used herein to describe the same. It will nevertheless be understood that no limitation of the scope of the disclosure is thereby intended. Alterations and further modifications of the inventive features illustrated herein and additional applications of the principles of the inventions as illustrated herein, which would occur to one skilled in the relevant art and having possession of this disclosure, are to be considered within the scope of the invention.

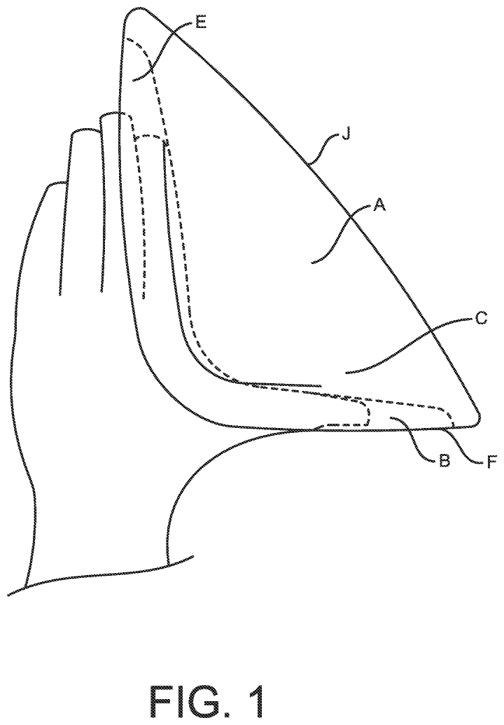

FIG. 1 is a top elevational view of the Thumb Stretch Wedge on the Right hand showing: Thumb saver made of non-slip rubber and plastic (it can be flipped to be used on the left or right hand) referenced as A., Groove on the side for thumb and index finger of smooth surface referenced as B., Sticky surface referenced as C., Fingers referenced as D., in accordance with an embodiment of the present disclosure. The disclosure also includes the tip E of the longer side or leg or index finger and the tip F of the shorter side leg of the thumb finger. The hypotenuse or J edge of the disclosed right triangle glove.

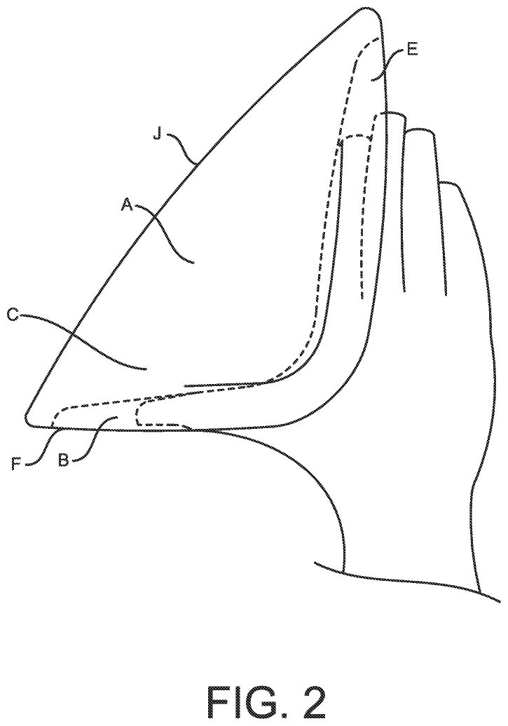

FIG. 2 is a top elevational view of the Thumb Stretch Wedge on the Left hand showing: Thumb saver made of non-slip rubber and plastic (it can be flipped to be used on the left or right hand) referenced as A., Groove on the side for thumb and index finger of smooth surface referenced as B., Sticky surface referenced as C., Fingers referenced as D., in accordance with an embodiment of the present disclosure. The disclosure also includes the tip E of the longer side or leg or index finger and the tip F of the shorter side leg of the thumb finger. The hypotenuse or J edge of the disclosed right triangle glove.

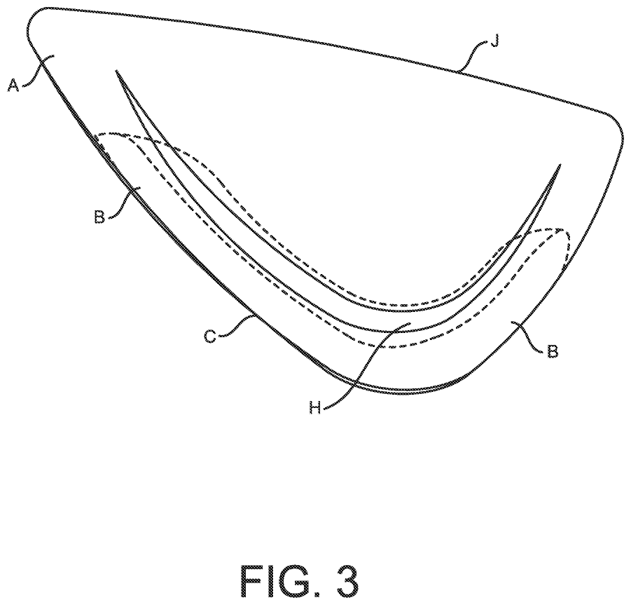

FIG. 3 is a bottom elevational view of the Thumb Stretch Wedge showing: Thumb saver made of non-slip rubber and plastic (it can be flipped to be used on the left or right hand) referenced as A., Groove on the side for thumb and index finger of smooth surface referenced as B., Sticky surface referenced as C., in accordance with an embodiment of the present disclosure. The present view also includes the right triangle ridge Hon an underside of the right triangle glove corresponding to a palm side of the user's hand.

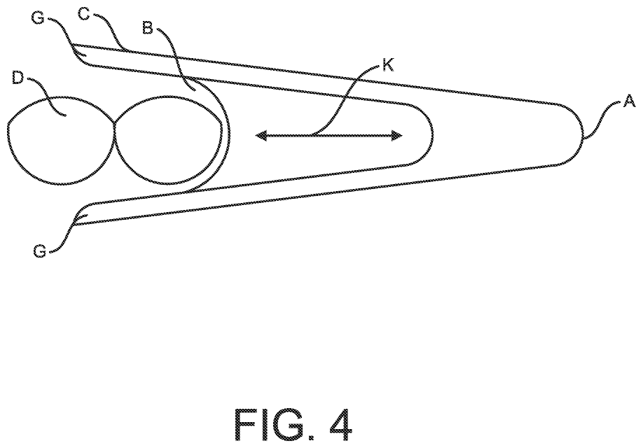

FIG. 4 is a side elevational view of the Thumb Stretch Wedge showing: Thumb saver made of non-slip rubber and plastic (it can be flipped to be to used on the left or right hand) referenced as A., Groove on the side for thumb and index finger of smooth surface referenced as B., Sticky surface referenced as C., Fingers referenced as D., in accordance with an embodiment of the present disclosure. The present view also includes the respective edge G of the short side edge or longer side edge of the groove of the right triangle glove. The view also includes the flaring K in response to a three the user exerts extending their thumb at a right angle to their index finger.

The present disclosed Thumb Stretch Wedge, also known as “Thumb Saver”, delivers a proper anatomical stretch of the thumb. The Thumb Saver extends the wrist joints and musculature to reduce the frequency, intensity, and chronic occurrence of several common repetitive strain injuries such as, but not limited to carpal tunnel syndrome, DeQuervain's syndrome, trigger thumb injury and texting thumb syndrome. This innovative, one size fits all, product introduces a novel triangular shaped object made of nonslip rubber and plastic with grooves to enable the user to simply glide their thumbs into the unit. The Thumb Saver delivers a mild stretch at the base of the thumb and the space between the thumb and index finger. The user pushes their hand towards the device and the amount of force the user exerts will determine the intensity of the stretch. The compact structure of the Thumb Saver ensures the product is unobtrusive on a workstation and can be easily carried around with an individual. With the Thumb Saver, a person can stretch while still working at their desk, talking on the phone, reading, and/or studying as it offers a fully operational, inconspicuous thumb and wrist relieving device that allows users to perform anatomically correct stretches to the thumb, wrist and index finger structures, at their leisure. This unprecedented product offers treatment post rehab for most hand and wrist surgeries, and other cumulative thumb and wrist disorders to guarantee the pain is treated adequately and easily.

Although the operations of the method(s) herein are shown and described in a particular order, the order of the operations of each method may be altered so that certain operations may be performed in an inverse order or so that certain operations may be performed, at least in part, concurrently with other operations. In another embodiment, instructions or sub-operations of distinct operations may be implemented in an intermittent and/or alternating manner.

What is claimed is:

1. A stretch assist device comprising:
a right triangle glove for a user's thumb and index finger wherein the user's thumb is received into a short side edge and the user's index finger is received into a longer side edge adjacent the short side edge;
a glove webbing between a tip of the short side edge and a tip of the longer side edge forming a hypotenuse edge of the right triangle glove; and
a groove in the short side edge and in the longer side edge, the groove configured to flare out from the glove webbing in response to a force the user exerts in extending their thumb at a right angle to their index finger.

2. The device of claim 1, wherein the elastic glove webbing comprises a non-slip rubber and plastic composite.

3. The device of claim 1, wherein the hypotenuse edge is bowed out away from a thenar webspace at a joining of the user's thumb and the user's index finger.

4. The device of claim 1, wherein the short side edge and the longer side edge are chamfered.

5. The device of claim 1, wherein the elastic glove webbing comprises a solid core having a thickness larger than a thickness of the user's thumb.

6. The device of claim 1, further comprising a sticky surface on the elastic glove webbing.

7. The device of claim 1, further comprising a right triangle ridge on an underside of the right triangle glove corresponding to a palm side of the user's hand.

8. The device of claim 1, further comprising a thenar webspace of the glove webbing between the user's thumb and index finger configured to maintain a right angle there between.

9. The device of claim 1, wherein the groove in the short side edge and the longer side edge comprises an inside chamfer.

10. The device of claim 1, wherein the glove webbing elastically responds to a stretch of the user of their thumb at a right angle to their index finger.

11. The device of claim 1, wherein the right triangle glove is configured to receive either a right hand or a left hand of the user.

12. The device of claim 1, further comprising a rigid right triangle spine disposed in the glove webbing and configured to support a stretch of the user's thumb from the user's index finger.
